(19) United States
(12) Patent Application Publication
(10) Pub. No.: US 2026/0161064 A1
(43) Pub. Date: Jun. 11, 2026

(54) PROJECTION DEVICE AND CONTROL METHOD THEREOF

(71) Applicant: Coretronic Corporation, Hsin-Chu (TW)

(72) Inventors: Tzu-Chuan TSENG, Hsin-Chu (TW); Yun-Tzai LIAO, Hsin-Chu (TW)

(21) Appl. No.: 19/385,171

(22) Filed: Nov. 11, 2025

(30) Foreign Application Priority Data
Dec. 10, 2024 (CN) 202411812903X

(51) Int. Cl. G03B 21/20

(52) U.S. Cl. CPC G03B 21/2053

(57) ABSTRACT

Disclosed is a projection device and a control method thereof. The projection device comprises a power conversion unit, a first detection unit, a second detection unit, a computation unit and a control unit. The computation unit receives a first voltage detection value from the first detection unit and a current detection value from the second detection unit. The computation unit calculates to obtain a total power consumption value according to the current detection value. The control unit controls power consumption of at least one power-consuming component according to the first voltage detection value and the total power consumption value, thereby well controlling the operational power consumption of the projection device.

This application claims the benefit of and priority to Chinese Patent Application No. 202411812903.X, filed on December 10, 2024, the disclosure of which is incorporated herein by reference in its entirety.

### BACKGROUND

### Technical Field

The present application relates to the field of optics and electrical device, and more particularly to a projection device and a control method thereof.

### DESCRIPTION OF THE RELATED ART

In accordance with power consumption regulations, conventional projection devices are configured with different power consumption thresholds depending on the operating voltage conditions. When the power consumption exceeds the corresponding threshold, the conventional approach is to cap/limit the device’s power at a fixed percentage (e.g., 80%) to meet regulatory requirements. However, this method imposes excessive restrictions on power usage, preventing the projection device from achieving optimal brightness performance.

Therefore, there is a need to provide an improved solution to overcome the deficiencies of the prior art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present application discloses a projection device and a control method thereof. By improving the power control mechanism of the projection device, the operating power consumption can be effectively managed, thereby enabling the device to achieve optimal brightness performance.

Additional objectives and advantages of the disclosure will become more apparent from the technical features disclosed herein.

To achieve one or more of the foregoing or other objectives, an embodiment of the disclosure provides a projection device comprising a power conversion unit, a first detection unit, a second detection unit, a computation unit, and a control unit. The power conversion unit is electrically coupled to at least one power-consuming component. The first detection unit is electrically coupled to the input end of the power conversion unit and is configured to detect the input voltage of the power conversion unit to generate a first voltage detection value. The second detection unit is electrically coupled to either the input end or an output end of the power conversion unit and is configured to detect the current at the input end or the output end to generate a current detection value. The computation unit is electrically coupled to both the first and second detection units and is configured to calculate to obtain the total power consumption value of at least one power-consuming component according to the current detection value, and to output the first voltage detection value and the total power consumption. The control unit is electrically coupled to the computation unit and the at least one power-consuming component and is configured to control power consumption of the at least one power-consuming component according to the first voltage detection value and the total power consumption value.

In one embodiment of the disclosure, the voltage received at the input end of the power conversion unit is an alternating current (AC) voltage, and the output end of the power conversion unit is electrically coupled to the at least one power-consuming component and is configured to output a direct current (DC) voltage to the at least one power-consuming component.

In one embodiment of the disclosure, the second detection unit is electrically coupled to the input end of the power conversion unit, and the computation unit is configured to calculate to obtain the total power consumption value according to the first voltage detection value and the current detection value.

In one embodiment of the disclosure, the second detection unit comprises an alternating current (AC) ammeter.

In one embodiment of the disclosure, the second detection unit and the computation unit are respectively electrically coupled to the output end of the power conversion unit, the computation unit is configured to detect a voltage at the output end of the power conversion unit to generate a second voltage detection value, and the computation unit is further configured to calculate to obtain the total power consumption value according to the second voltage detection value and the current detection value.

In one embodiment of the disclosure, the second detection unit comprises a Hall-effect current sensor.

In one embodiment of the disclosure, the control unit is configured to determine, according to the first voltage detection value, whether the voltage input to the power conversion unit is at a low voltage level or a high voltage level, wherein the low voltage level corresponds to a first power threshold, and the high voltage level corresponds to a second power threshold.

In one embodiment of the disclosure, the control unit is configured to: in response to the first voltage detection value corresponding to the low voltage level, determine whether the total power consumption value exceeds the first power threshold, and when the total power consumption value exceeds the first power threshold, generate a control signal according to the total power consumption value and the first power threshold to reduce the power consumption of the at least one power-consuming component; and in response to the first voltage detection value corresponding to the high voltage level, determine whether the total power consumption value exceeds the second power threshold, and when the total power consumption value exceeds the second power threshold, generate the control signal according to the total power consumption value and the second power threshold to reduce the power consumption of the at least one power-consuming component.

In one embodiment of the disclosure, an number of the at least one power-consuming component is plural, each of the power-consuming components comprises a corresponding power consumption value, and the total of the corresponding power consumption values of each of the power-consuming components constitutes the total power consumption value, and the power-consuming components comprises at least one of a light source module, a heat dissipation module, and a drive module.

In one embodiment of the disclosure, the control unit is configured to: in response to the first voltage detection value corresponding to the low voltage level and the total power consumption value being greater than the first power threshold, generate a control signal to reduce the power consumption value of at least one of the power-consuming components so that the reduced total power consumption value is less than or equal to the first power threshold; and in response to the first voltage detection value corresponding to the high voltage level and the total power consumption value being greater than the second power threshold, generate the control signal to reduce the power consumption value of at least one of the power-consuming components so that the reduced total power consumption value is less than or equal to the second power threshold.

To achieve one or more of the foregoing or other objectives, another embodiment of the disclosure provides a method for controlling a projection device comprising a power conversion unit, a first detection unit, a second detection unit, a computation unit, and a control unit. The control method includes: detecting, via the first detection unit, the voltage input to the power conversion unit to generate a first voltage detection value; detecting, via the second detection unit, the current at an input end or an output end of the power conversion unit to generate a current detection value; calculating, via the computation unit, to obtain the total power consumption value of at least one power-consuming component according to the current detection value and outputting the first voltage detection value and the total power consumption value; and controlling, via the control unit, power consumption of the at least one power-consuming component according to the first voltage detection value and the total power consumption value.

In one embodiment of the disclosure, the step of calculating, by the computation unit, to obtain the total power consumption value corresponding to the at least one power-consuming component according to the current detection value further comprises the step of: calculating, by the computation unit, to obtain the total power consumption value corresponding to the at least one power-consuming component according to the first voltage detection value and the current detection value.

In one embodiment of the disclosure, after the step of detecting a current at the input end or the output end of the power conversion unit by the second detection unit to generate a current detection value further comprises the step of: detecting, by the computation unit, the voltage at the output end of the power conversion unit to generate a second voltage detection value.

In one embodiment of the disclosure, the step of calculating, by the computation unit, to obtain a total power consumption value corresponding to at least one power-consuming component according to the current detection value further comprises the step of: calculating, by the computation unit, to obtain the total power consumption value corresponding to the at least one energy-consuming component according to the second voltage detection value and the current detection value.

In one embodiment of the disclosure, the step of controlling, by the control unit, the power consumption of the at least one power-consuming component according to the first voltage detection value and the total power consumption value comprises: determining, by the control unit, whether the voltage input to the power conversion unit is at a low voltage level or a high voltage level according to the first voltage detection value; in response to the first voltage detection value corresponding to the low voltage level, determining, by the control unit, whether the total power consumption value is greater than a first power threshold; when the total power consumption value is greater than the first power threshold, generating, by the control unit, a control signal according to the total power consumption value and the first power threshold to reduce the power consumption of the at least one energy-consuming component; and in response to the first voltage detection value corresponding to the high voltage level, determining, by the control unit, whether the total power consumption value is greater than a second power threshold; when the total power consumption value is greater than the second power threshold, generating, by the control unit, the control signal according to the total power consumption value and the second power threshold to reduce the power consumption of the at least one energy-consuming component.

In one embodiment of the disclosure, wherein an number of the at least one power-consuming component is plural, each of the power-consuming components comprises a corresponding power consumption value, and the total of the corresponding power consumption values of each of the power-consuming components constitutes the total power consumption value, and the step of controlling, by the control unit, the power consumption of the at least one power-consuming component according to the first voltage detection value and the total power consumption value comprises: determining, by the control unit, whether the voltage input to the power conversion unit is at a low voltage level or a high voltage level according to the first voltage detection value; in response to the first voltage detection value corresponding to the low voltage level, determining, by the control unit, whether the total power consumption value is greater than a first power threshold; when the total power consumption value is greater than the first power threshold, generating, by the control unit, a control signal according to the total power consumption value and the first power threshold to reduce the power consumption of the at least one energy- consuming component so that the reduced total power consumption value is less than or equal to the first power threshold; and in response to the first voltage detection value corresponding to the high voltage level, determining, by the control unit, whether the total power consumption value is greater than a second power threshold; when the total power consumption value is greater than the second power threshold, generating, by the control unit, the control signal according to the total power consumption value and the second power threshold to reduce the power consumption of the at least one energy-consuming component so that the reduced total power consumption value is less than or equal to the second power threshold.

According to the foregoing, the embodiments of the disclosure provide at least one of the following advantages. In the disclosed embodiments, the computation unit calculates to obtain the total power consumption value of at least one power-consuming component according to the current detection value. The control unit then adjusts the power consumption of the power-consuming component(s) according to the first voltage detection value and the total power consumption value. As a result, the projection device's operating power can be effectively controlled to achieve an optimized brightness performance.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF DRAWINGS

The accompanying drawings presented herein serve to deepen the understanding of the disclosure and are an integral part thereof. The illustrative embodiments and their explanations are provided to elucidate the disclosure and do not impose any undue limitations on it. In the drawings:

FIG. 1 is a block diagram of a first embodiment of a projection device according to the disclosure;

FIG. 2 is a block diagram of a second embodiment of a projection device according to the disclosure;

FIG. 3 is a graph showing the relationship between the pulse width modulation (PWM) parameter and current of the light source in the light source module of a projection device according to an embodiment of the disclosure;

FIG. 4 is another block diagram of the second embodiment of the projection device according to the disclosure;

FIG. 5 is a flowchart illustrating an embodiment of the control method for a projection device according to the disclosure; and

FIG. 6 is another flowchart illustrating an embodiment of the control method for a projection device according to the disclosure.

### DETAILED DESCRIPTION

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

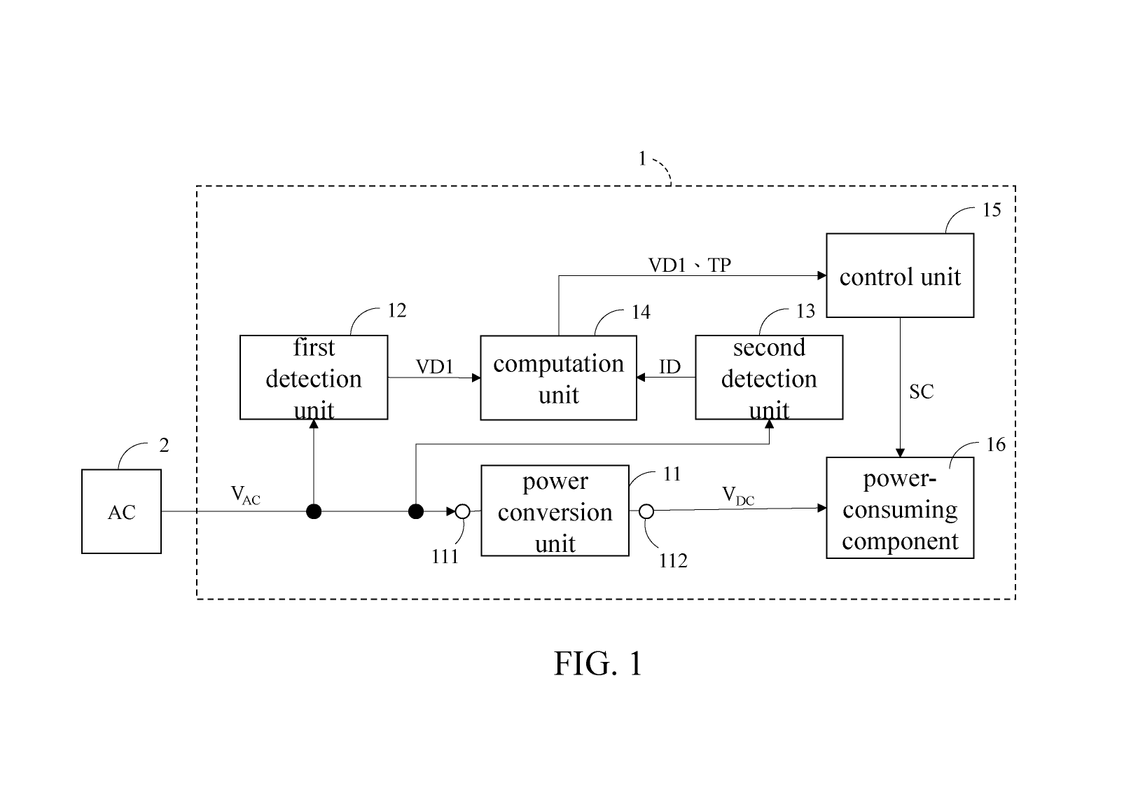

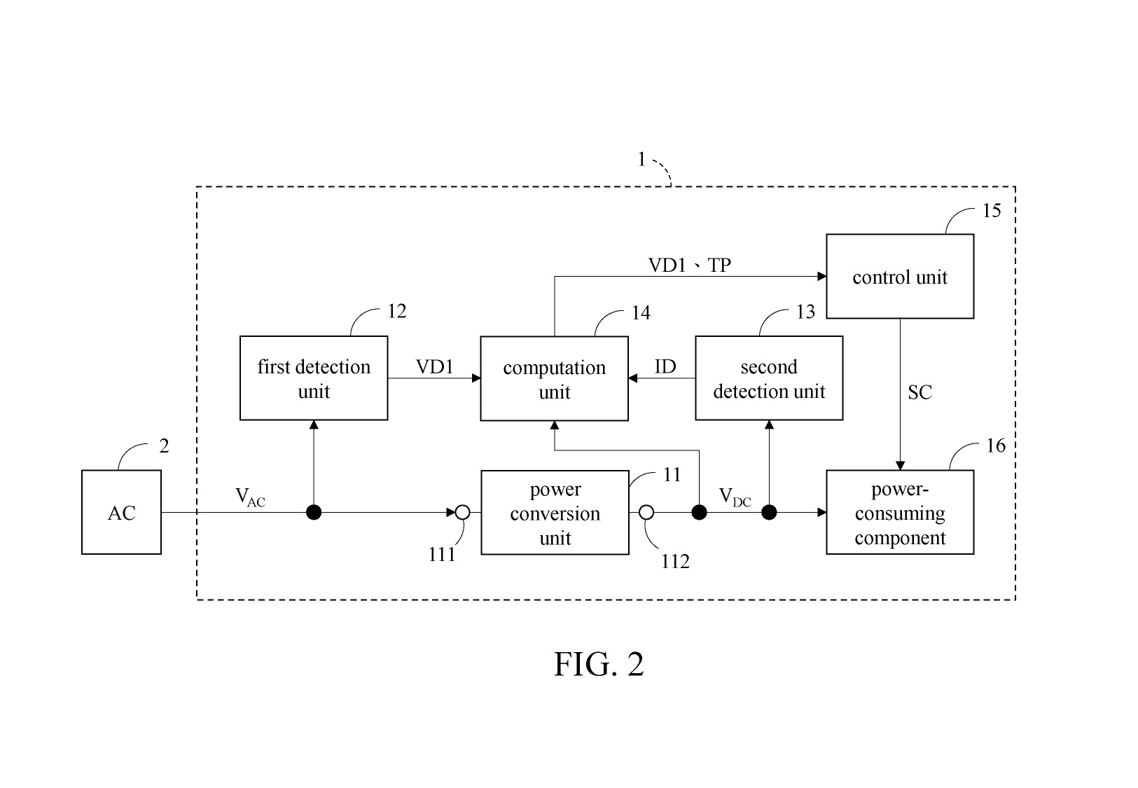

Referring to FIGS. 1 and 2, a projection device 1 according to an embodiment of the disclosure includes a power conversion unit 11, a first detection unit 12, a second detection unit 13, a computation unit 14, and a control unit 15. The power conversion unit 11 has an input end 111 and an output end 112, and is electrically coupled to at least one power-consuming component 16 of the projection device 1. The first detection unit 12 is electrically coupled to the input end 111 of the power conversion unit 11 and is configured to detect the voltage input to the input end 111, thereby generating a first voltage detection value VD1. The second detection unit 13 is electrically coupled to either the input end 111 or the output end 112 of the power conversion unit 11 and is configured to detect the current at the input end or an output end, thereby generating a current detection value ID. The computation unit 14 is electrically coupled to the first detection unit 12 and the second detection unit 13 respectively, and is configured to calculate to obtain a total power consumption value TP corresponding to at least one power-consuming component 16 according to the current detection value ID received from the second detection unit 13. The computation unit 14 outputs the first voltage detection value VD1 and the total power consumption value TP. The control unit 15 is electrically coupled to the computation unit 14 and to the at least one power-consuming component 16, and is configured to control the power consumption of the power-consuming component(s) according to the first voltage detection value VD1 and the total power consumption value TP received from the computation unit 14. This enables effective control of the operating power of the projection device, allowing the projection device to achieve optimized brightness performance. The first and second embodiments will be described in further detail below.

As shown in FIG. 1, in the first embodiment of the disclosure, the power conversion unit 11 may be an AC-DC converter or an AC-DC circuit. The input end 111 of the power conversion unit 11 is electrically coupled to an external AC power source 2, and receives an AC voltage V_{AC} from the external AC power source 2. For example, the external AC power source 2 is indoor power supply (electrical socket). AC is alternating current and DC is direct current. The output end 112 of the power conversion unit 11 is electrically coupled to at least one power-consuming component 16. The power conversion unit 11 is configured to convert the high-voltage AC voltage V_{AC} into a DC voltage V_{DC} required by the at least one power-consuming component 16, and to output the DC voltage V_{DC} to the power-consuming component(s) 16 via its output end 112.

In the first embodiment of the disclosure, the second detection unit 13 is electrically coupled to the input end 111 of the power conversion unit 11. The second detection unit 13 is configured to detect the AC current input to the input end 111 and to generate a current detection value ID for the computation unit 14. The computation unit 14 may be a microcontroller (MCU). The computation unit 14 is configured to calculate to obtain a total power consumption value TP of at least one power-consuming component 16 according to the first voltage detection value VD1 and the current detection value ID, and to output the first voltage detection value VD1 and the total power consumption value TP to the control unit 15. For example, the computation unit 14 may multiply the first voltage detection value VD1 by the current detection value ID to calculate to obtain the total power consumption value TP.

In the first embodiment of the disclosure, the first detection unit 12 may be a voltage detection chip, a voltage detection circuit or a microcontroller (MCU). The second detection unit 13 may be an AC current meter. In the embodiment, the first detection unit 12 and the second detection unit 13 may be integrated into a single detection chip or a single detection circuit. Alternatively, the first detection unit 12 and the second detection unit 13 may respectively be a microcontroller (MCU) and an AC current meter. In one embodiment, the power conversion unit 11, the first detection unit 12, the second detection unit 13, and the computation unit 14 may be integrated on a low voltage power supply (LVPS) board. The LVPS board serves as a circuit board that supplies stable low-voltage power to the projection device 1.

As shown in FIG. 1, in the first embodiment of the disclosure, the control unit 15 is configured to determine whether the voltage input to the input end 111 of the power conversion unit 11 (i.e., the AC voltage V_{AC}) corresponds to a low voltage level or a high voltage level according to the first voltage detection value VD1. This determination allows the projection device 1 to identify the applicable power (consumption) limit according to the detected voltage level. The low voltage level corresponds to a first power threshold, and the high voltage level corresponds to a second power threshold. For example, the low voltage level and high voltage level may be 110 volts and 220 volts, respectively. The first power threshold may be lower than the second power threshold, for instance, 1350 watts and 2470 watts, respectively. In the first embodiment of the disclosure, the control unit 15 may be a microcontroller (MCU).

In the first embodiment of the disclosure, the control unit 15 is configured to, in response to the first voltage detection value VD1 indicating a low voltage level, determine whether the current total power consumption value TP of the at least one power-consuming component 16 exceeds the first power threshold. When the control unit 15 determines that the total power consumption value TP exceeds the first power threshold, the control unit 15 generates a control signal SC according to the ratio of the total power consumption value TP to the first power threshold. The control signal SC is transmitted to the at least one power-consuming component 16 to reduce its power consumption such that the adjusted total power consumption value TP is less than or equal to the first power threshold. When the control unit 15 determines that the current total power consumption value TP is less than or equal to the first power threshold, the control unit 15 does not generate any control signal SC to reduce power consumption, thereby maintaining the current operating power of the projection device 1.

In the first embodiment of the disclosure, the control unit 15 is configured to, in response to the first voltage detection value VD1 indicating a high voltage level, determine whether the current total power consumption value TP of the at least one power-consuming component 16 exceeds the second power threshold. When the control unit 15 determines that the total power consumption value TP exceeds the second power threshold, the control unit 15 generates a control signal SC according to the ratio of the total power consumption value TP to the second power threshold. The control signal SC is transmitted to the at least one power-consuming component 16 to reduce its power consumption such that the adjusted total power consumption value TP is less than or equal to the second power threshold. When the control unit 15 determines that the current total power consumption value TP is less than or equal to the second power threshold, the control unit 15 does not generate any control signal SC to reduce power consumption, thereby maintaining the current operating power of the projection device 1.

With this configuration, the control unit 15 may automatically reduce the power consumption of the at least one power-consuming component 16 according to the first voltage detection value VD1 and the total power consumption value TP, such that the adjusted total power consumption value TP is less than or equal to the first power threshold/second power threshold. Furthermore, the control unit 15 adjusts the total power consumption value TP to fall within a range of 90% to 100% of the first or second power threshold. This approach not only enables effective control of the operating power of the projection device 1 to ensure compliance with power consumption regulations, but also allows the projection device 1 to achieve optimized brightness performance.

In the first embodiment of the disclosure, the number of power-consuming components 16 may be plural. Each power-consuming component 16 has a corresponding power consumption value, and the total sum of these power consumption values constitutes the total power consumption value TP described above. The multiple power-consuming components 16 may include, for example, a light source module, a heat dissipation module, a driving module, or other components. For example, the light source module may include a light source, which may comprise at least one of a light-emitting diode (LED) and a laser diode. The heat dissipation module may include at least one fan, and the driving module may include at least one of a driver circuit board of the light source, a driver circuit board of Digital Micromirror Device (DMD) and a motor.

In the first embodiment of the disclosure, the control unit 15 is configured to, in response to the first voltage detection value VD1 indicating a low voltage level, determine whether the total power consumption value TP exceeds the first power threshold. When the control unit 15 determines that the total power consumption value TP exceeds the first power threshold, the control unit 15 generates a control signal SC according to the total power consumption value TP and the first power threshold, and transmits the control signal SC to at least one of the multiple power-consuming components 16 to reduce its power consumption. This reduction causes the adjusted total power consumption value TP to become less than or equal to the first power threshold.

In the first embodiment of the disclosure, the control unit 15 is configured to, in response to the first voltage detection value VD1 indicating a high voltage level, determine whether the total power consumption value TP exceeds the second power threshold. When the control unit 15 determines that the total power consumption value TP exceeds the second power threshold, the control unit 15 generates a control signal SC according to the total power consumption value TP and the second power threshold, and transmits the control signal SC to at least one of the multiple power-consuming components 16 to reduce its power consumption. This reduction causes the adjusted total power consumption value TP to become less than or equal to the second power threshold.

In one embodiment, when the control unit 15 determines that the current total power consumption value TP exceeds the first power threshold/second power threshold, the control unit 15 may generate a control signal SC through computation. The control signal SC may be transmitted to one, multiple, or all of the power-consuming components 16. For example, when it is desired to reduce the power consumption of all of the multiple power-consuming components 16, the control unit 15 may calculate the reduction amount required by the multiple power-consuming components 16 according to the ratio between first power threshold/second power threshold and the current total power consumption value TP. Suppose the current value TP is 1408 watts, and the first power threshold is 1350 watts. The control unit 15 determines that a reduction of 58 watts is needed. According to the required reduction (58 W) and the current value TP (1408 W), the control unit 15 calculates that each component needs to reduce power by approximately 4% to 5%, i.e., to about 95% to 96% of its current power consumption. The control unit 15 then generates a control signal SC corresponding to the above conditions to all of the multiple power-consuming components 16. When it is desired to reduce the power consumption of one or more (but not all) of the multiple of power-consuming components 16, the control unit 15 may determine the reduction amount for the targeted power-consuming components 16 according to the ratio between the required power reduction (i.e., the difference between the first power threshold/second power threshold and the current total power consumption value TP) and the current power consumption of the targeted power-consuming components 16. For instance, in response to the first voltage detection value VD1 indicating a low voltage level, assume it is desired to reduce the power consumption of the light source module among the multiple power-consuming components 16. Suppose the current value TP is 1590 watts, the current power consumption of the light source module is 1248 watts, and the first power threshold is 1350 watts. It can be determined by the control unit 15 that a reduction amount of 240 watts in power consumption is required. According to the total reduction amount (240 W) and the current power consumption (1248 W) of the light source module, the control unit 15 calculates that the light source module should reduce its power by approximately 20%, i.e., to about 80% of its current value. Accordingly, the control unit 15 generates a control signal SC for the light source module to reduce its power to approximately 999 watts (a reduction of about 249 W). The resulting total power consumption value TP after reduction becomes 1341 watts (1590 – 249), which is less than or equal to the first power threshold of 1350 watts.

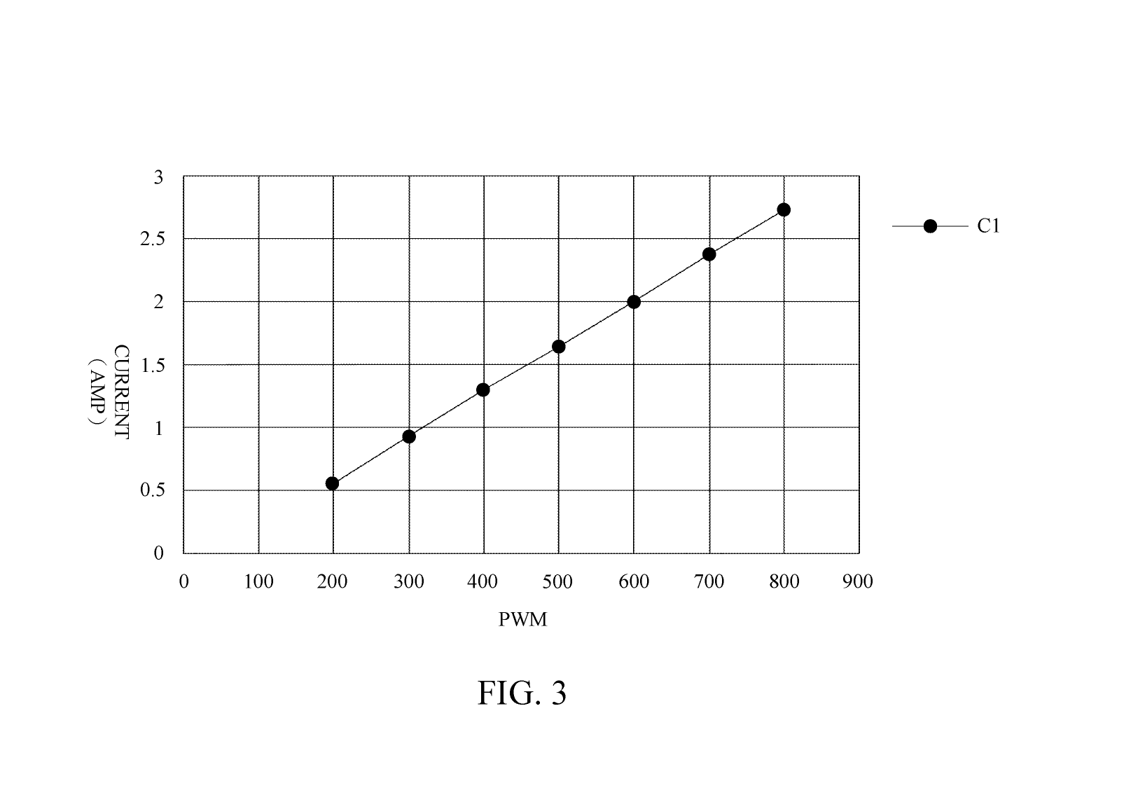

In one embodiment, when the control unit 15 determines that the current total power consumption value TP exceeds the first power threshold/second power threshold, the control unit 15 may generate a corresponding control signal SC by referencing a lookup table. The control signal SC may be transmitted to one, multiple, or all of the power-consuming components 16. For example, when it is desired to reduce the power consumption of all of the multiple power-consuming components 16, the control unit 15 generates the control signal SC according to the lookup table. For example, In response to the first voltage detection value VD1 indicating a low voltage level, given that the first power threshold is 1350 watts and the current value TP is 1590 watts, the control unit 15 refers to the lookup table to determine the corresponding current power consumption (or corresponding current values) of each power-consuming component 16 watts when the total power consumption value TP is 1590. The control unit 15 then uses the lookup table to identify the corresponding power consumption (or corresponding current) of each power-consuming component 16 under conditions where the adjusted total power consumption value TP is not greater than the first power threshold (1350 watts). According to this information, the control unit 15 determines the reduction amount of the power consumption (or current) required by each power-consuming component 16 and generates the corresponding control signal SC. When it is desired to reduce the power consumption of one or more (but not all) of the power-consuming components 16, the control unit may likewise generate the control by using the lookup table. For example, when reducing the power consumption of the light source module among the components 16, and when the control unit 15 determines that the current total power consumption value TP (e.g., 1590 watts) exceeds the first power threshold (e.g., 1350 watts), the control unit 15 determines that a 240-watt reduction is required. It is then referred to the lookup table to find the correspond reduction amount of 0.4 amps for the light source. Please refer to FIGS. 1 and 3. The curve C1 in FIG. 3 illustrates the relationship between the pulse width modulation (PWM) parameter and the current (in amperes) of the light source in the light source module. The control unit 15 determines, from curve C1, that the current corresponding to the present PWM parameter of 600 is approximately 2 amps, and from looking up the table, that the reduction amount of the current of the light source is 0.4 amps, the control unit 15 determines that the adjusted current for the light source is 1.6 amps. And the adjusted PWM parameter is 500. The control unit 15 then generates a control signal SC corresponding to this PWM parameter (500) and transmit the control signal SC to the light source module. As a result, the total power consumption value TP is reduced to equal or less than the first power threshold (1350 watts), thereby achieving compliance with power consumption regulations by adjusting the power of only a single component (the light source module).

Referring to FIG. 2, a second embodiment of the disclosure is illustrated. The main technical features of this embodiment are similar to those described in the first embodiment, and the same functions and advantages will not be repeated here for brevity. The primary difference lies in the configuration of the second detection unit 13, which is electrically coupled to the output end 112 of the power conversion unit 11 in the second embodiment.

In the second embodiment, the second detection unit 13 is configured to detect the direct current (DC) output from the output end 112 and to generate a current detection value ID to the computation unit 14. In one embodiment, the computation unit 14 is electrically coupled to the output end 112 of the power conversion unit 11 and is configured to detect the DC voltage V_{DC} output from the output end 112 to generate a second voltage detection value. The computation unit 14 is further configured to calculate to obtain the total power consumption value TP according to the second voltage detection value and the current detection value ID. For example, the computation unit 14 may multiply the second voltage detection value by the current detection value ID, then sum the result, and subsequently multiply by the conversion efficiency to calculate to obtain the total power consumption value TP. The conversion efficiency may correspond to the efficiency between the input and output of the power conversion unit 11, and the error in conversion efficiency may range from approximately 3% to 5%.

In the second embodiment of the disclosure, the second detection unit 13 may be, for example, a Hall-effect current sensor, and the computation unit 14 may be a microcontroller (MCU).

In the second embodiment of the disclosure, the detection of the DC voltage V_{DC} may also be performed by another microcontroller. This additional microcontroller is electrically coupled to the computation unit 14 and the output end 112 of the power conversion unit 11 respectively. The additional microcontroller transmits the second voltage detection value to the computation unit 14, which then calculates to obtain the total power consumption value TP according to the second voltage detection value and the current detection value ID.

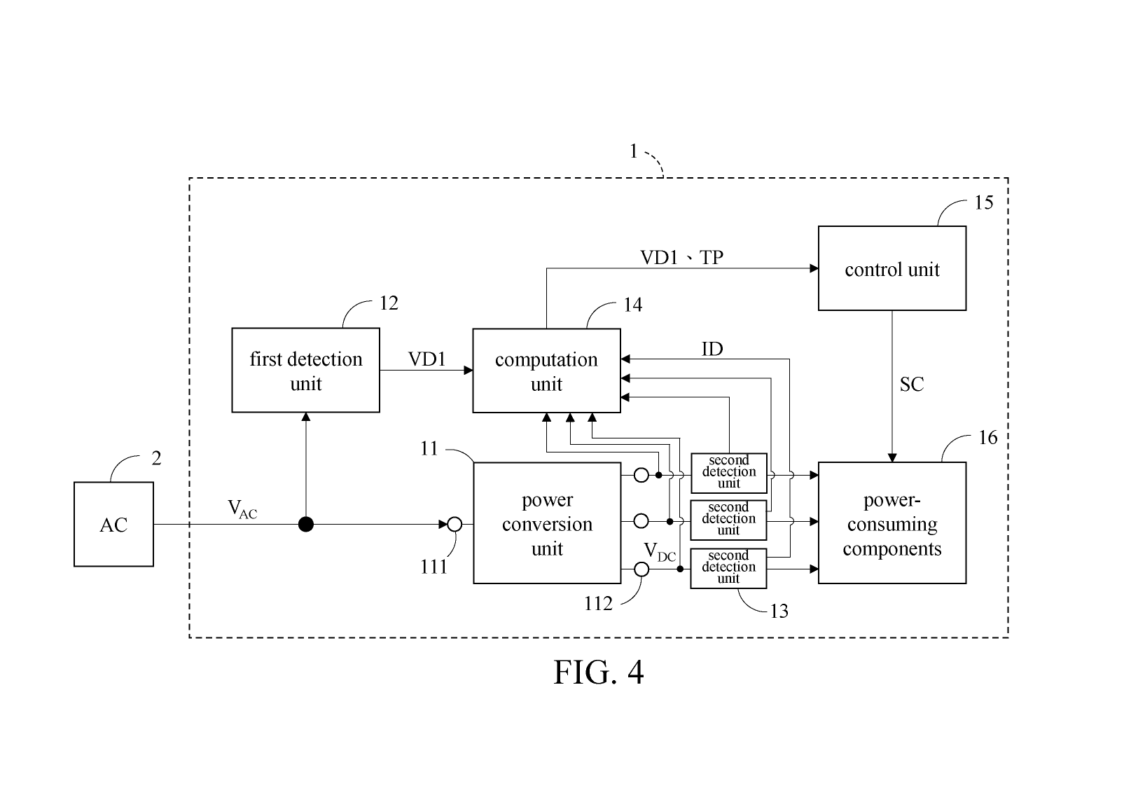

Referring to FIG. 4, in the second embodiment of the disclosure, the power conversion unit 11 may also include a plurality of output ends 112. The multiple output ends 112 are respectively electrically coupled to a plurality of power-consuming components 16, and each is configured to output a DC voltage V_{DC} of a different voltage level to the corresponding power-consuming component 16. A plurality of second detection units 13 may be provided, with each second detection unit 13 electrically coupled to a respective output end 112 to detect the DC current output therefrom and to generate a corresponding current detection value ID to the computation unit 14. The computation unit 14 is also electrically coupled to the plurality of output ends 112 to detect the respective DC voltages V_{DC} and to generate corresponding second voltage detection values. The computation unit 14 may calculate to obtain the total power consumption value TP by multiplying each current detection value ID by its corresponding second voltage detection value, summing the results, and then applying the conversion efficiency.

For example, the power conversion unit 11 may include three output ends 112 that output DC voltages of 52 volts, 12.2 volts, and 5.1 volts, and corresponding DC currents of 35 amps, 22 amps, and 5.1 amps, respectively. In this case, three second detection units 13 are provided, each detecting the current from a respective output end 112 and generating three current detection values ID (35 A, 22 A, and 5.1 A) to the computation unit 14. The computation unit 14 detects the DC voltages from the three output ends 112 and generates three second voltage detection values (52 V, 12.2 V, and 5.1 V). The computation unit 14 then multiplies the three current detection values ID (35 A, 22 A, and 5.1 A) by the corresponding second voltage detection values (52 V, 12.2 V, and 5.1 V). The computation unit 14 then sums these values (35 A × 52 V = 1820 W, 22 A × 12.2 V = 268.4 W, 5.1 A × 5.1 V = 26.01 W) and multiplies the result by the conversion efficiency to calculate to obtain the total power consumption value TP.

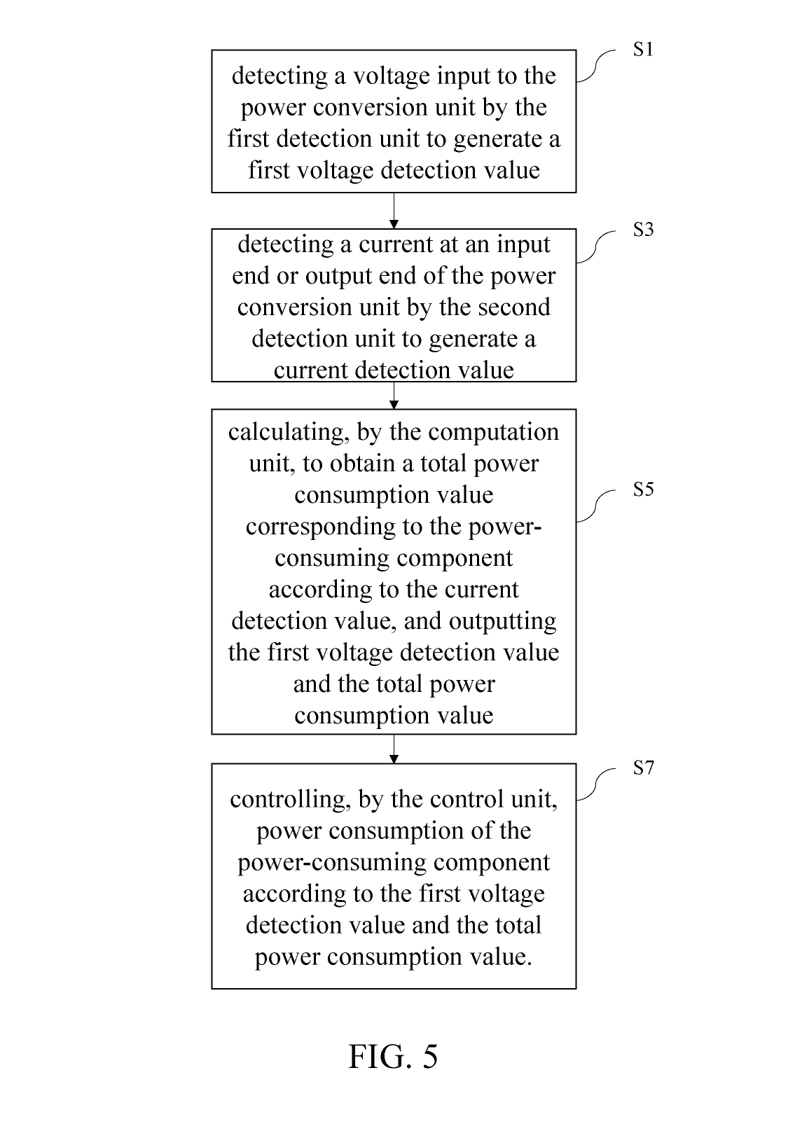

FIG. 5 illustrates a control method for a projection device according to an embodiment of the disclosure. For example, the projection device 1 shown in FIGS. 1 and 2 may be used to perform the control method illustrated in FIG. 5. The control method includes the following steps.

The step S1 involves detecting the voltage input to the input end 111 of the power conversion unit 11 by the first detection unit 12, and generating a first voltage detection value VD1 to be sent to the computation unit 14.

The step S3 involves detecting the current at the input end 111 or output end 112 of the power conversion unit 11 by the second detection unit 13, and generating a current detection value ID to be sent to the computation unit 14.

The step S5 involves calculating to obtain the total power consumption value TP corresponding to at least one power-consuming component 16 according to the current detection value ID by the computation unit 14, and outputting the first voltage detection value VD1 and the total power consumption value TP to the control unit 15.

The step S7 involves controlling the power consumption of at least one power-consuming component 16 by the control unit 15 according to the first voltage detection value VD1 and the total power consumption value TP.

Through the above steps, the computation unit 14 calculates to obtain the total power consumption value TP corresponding to at least one power-consuming component 16 according to the current detection value ID. The control unit 15 then controls the power consumption of the power-consuming component(s) according to the first voltage detection value VD1 and the total power consumption value TP, thereby enabling effective control of the operating power of the projection device and achieving optimized brightness performance.

In an embodiment of the disclosure, when the second detection unit 13 is electrically coupled to the input end 111 of the power conversion unit 11, after the current at the input end 111 is detected by the second detection unit 13 in step S3 and the current detection value ID is generated, the step S5 that the computation unit 14 calculates to obtain the total power consumption value TP corresponding to at least one power-consuming component 16 according to the current detection value ID may further include: calculating to obtain the total power consumption value TP by the computation unit 14 according to both the first voltage detection value VD1 and the current detection value ID.

In another embodiment of the disclosure, when the second detection unit 13 is electrically coupled to the output end 112 of the power conversion unit 11, after the current at the output end 112 is detected by the second detection unit 13 in step S3 and the current detection value ID is generated, the control method may further include the following step: detecting the voltage at the output end 112 of the power conversion unit 11 by the computation unit 14 to generate a second voltage detection value. In this embodiment, the step S5 that the computation unit 14 calculates to obtain the total power consumption value TP corresponding to at least one power-consuming component 16 according to the current detection value ID may further include: calculating to obtain the total power consumption value TP by the computation unit 14 according to the second voltage detection value and the current detection value ID.

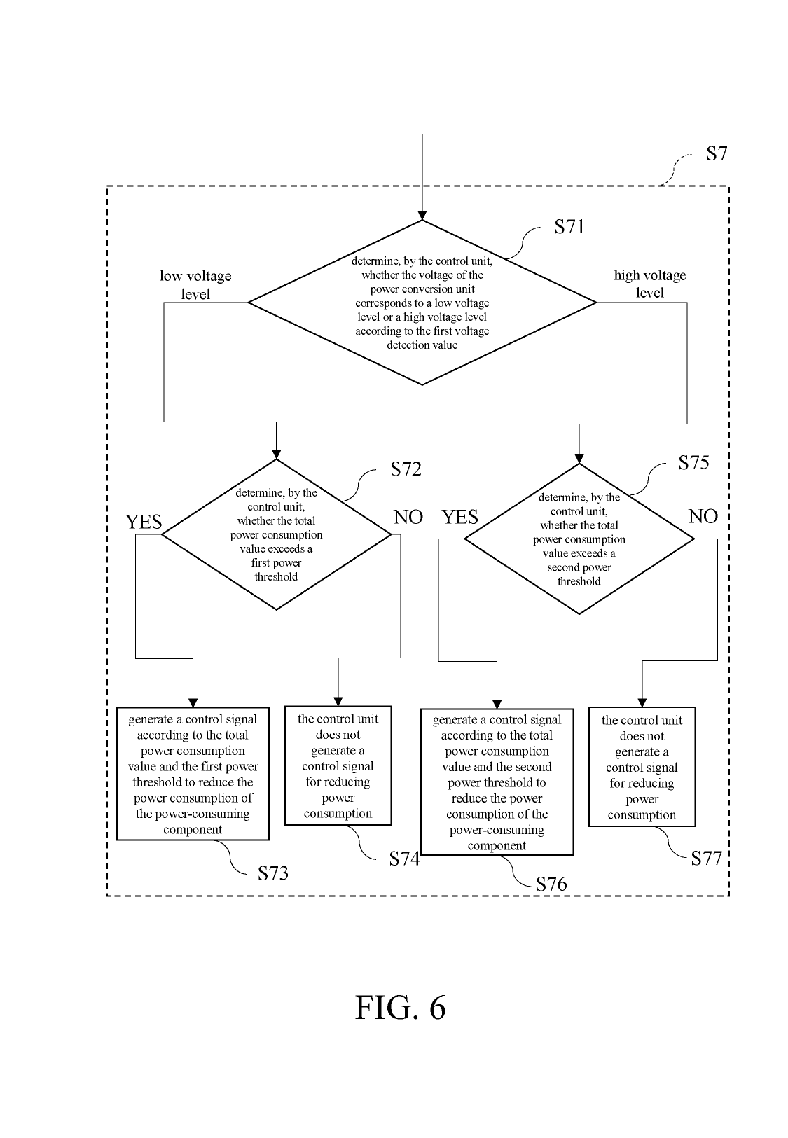

Referring to FIG. 6, in an embodiment of the disclosure, step S7 in FIG. 5 where the control unit 15 controls the power consumption of at least one power-consuming component 16 according to the first voltage detection value VD1 and the total power consumption value TP may further include the following steps.

The step S71 involves determining, by the control unit 15, whether the voltage input to the input end 111 of the power conversion unit 11 corresponds to a low voltage level or a high voltage level according to the first voltage detection value VD1.

When the first voltage detection value VD1 corresponds to a low voltage level, the control unit 15 determines whether the total power consumption value TP exceeds the first power threshold (S72). When the total power consumption value TP exceeds the first power threshold, the control unit 15 generates a control signal SC according to the total power consumption value TP and the first power threshold to reduce the power consumption of at least one power-consuming component 16 (S73). When the total power consumption value TP is less than or equal to the first power threshold, the control unit 15 does not generate any control signal SC for reducing the power consumption of the at least one power-consuming component 16 (S74).

When the first voltage detection value VD1 corresponds to a high voltage level, the control unit 15 determines whether the total power consumption value TP exceeds the second power threshold (S75). When the total power consumption value TP exceeds the second power threshold, the control unit 15 generates a control signal SC according to the total power consumption value TP and the second power threshold to reduce the power consumption of at least one power-consuming component 16 (S76). When the total power consumption value TP is less than or equal to the second power threshold, the control unit 15 does not generate any control signal SC for reducing the power consumption of the at least one power-consuming component 16 (S77).

In this embodiment, the number of power-consuming components 16 may be multiple. Each power-consuming component 16 has a corresponding power consumption value, and the sum of these values constitutes the total power consumption value TP described above. When the control unit 15 determines that the total power consumption value TP exceeds the first or second power threshold, it generates a control signal SC to at least one of the multiple power-consuming components 16 to reduce the power consumption of at least one of them, such that the adjusted total power consumption value TP is less than or equal to the first or second power threshold.

In summary, the projection device and control method according to embodiments of the disclosure offer at least the following advantage. By receiving a first voltage detection value VD1 from the first detection unit 12 and a current detection value ID from the second detection unit 13, the computation unit 14 can calculate to obtain a total power consumption value TP corresponding to at least one power-consuming component 16 according to the current detection value ID. The control unit 15 can then automatically reduce the power consumption of at least one power-consuming component 16 according to the first voltage detection value VD1 and the total power consumption value TP, such that the adjusted total power consumption value TP is less than or equal to the first or second power threshold. This configuration not only enables effective control of the operating power of the projection device 1 to ensure compliance with power consumption regulations, but also allows the projection device 1 to achieve optimized brightness performance.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present application” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

1. A projection device comprising:
a power conversion unit electrically coupled to at least one power-consuming component;
a first detection unit electrically coupled to an input end of the power conversion unit, the first detection unit configured to detect a voltage input to the power conversion unit and to generate a first voltage detection value;
a second detection unit electrically coupled to one of the input end and an output end of the power conversion unit, the second detection unit configured to detect a current at one of the input end and the output end and to generate a current detection value;
a computation unit electrically coupled to the first detection unit and the second detection unit respectively, configured to calculate to obtain a total power consumption value of the at least one power-consuming component according to the current detection value, and to output the first voltage detection value and the total power consumption value; and
a control unit electrically coupled to the computation unit and the at least one power-consuming component, configured to control power consumption of the at least one power-consuming component according to the first voltage detection value and the total power consumption value.

2. The projection device of claim 1, wherein the voltage received at the input end of the power conversion unit is an alternating current (AC) voltage, and the output end of the power conversion unit is electrically coupled to the at least one power-consuming component and is configured to output a direct current (DC) voltage to the at least one power-consuming component.

3. The projection device of claim 2, wherein the second detection unit is electrically coupled to the input end of the power conversion unit, and the computation unit is configured to calculate to obtain the total power consumption value according to the first voltage detection value and the current detection value.

4. The projection device of claim 3, wherein the second detection unit comprises an alternating current (AC) ammeter.

5. The projection device of claim 2, wherein the second detection unit and the computation unit are respectively electrically coupled to the output end of the power conversion unit, the computation unit is configured to detect a voltage at the output end of the power conversion unit to generate a second voltage detection value, and the computation unit is further configured to calculate to obtain the total power consumption value according to the second voltage detection value and the current detection value.

6. The projection device of claim 5, wherein the second detection unit comprises a Hall-effect current sensor.

7. The projection device of claim 1, wherein the control unit is configured to determine, according to the first voltage detection value, whether the voltage input to the power conversion unit is at a low voltage level or a high voltage level, wherein the low voltage level corresponds to a first power threshold, and the high voltage level corresponds to a second power threshold.

8. The projection device of claim 7, wherein the control unit is configured to:
in response to the first voltage detection value corresponding to the low voltage level, determine whether the total power consumption value exceeds the first power threshold, and when the total power consumption value exceeds the first power threshold, generate a control signal according to the total power consumption value and the first power threshold to reduce the power consumption of the at least one power-consuming component; and
in response to the first voltage detection value corresponding to the high voltage level, determine whether the total power consumption value exceeds the second power threshold, and when the total power consumption value exceeds the second power threshold, generate the control signal according to the total power consumption value and the second power threshold to reduce the power consumption of the at least one power-consuming component.

9. The projection device of claim 7, wherein an number of the at least one power-consuming component is plural, each of the power-consuming components comprises a corresponding power consumption value, and the total of the corresponding power consumption values of each of the power-consuming components constitutes the total power consumption value, and the power-consuming components comprises at least one of a light source module, a heat dissipation module, and a drive module.

10. The projection device of claim 9, wherein the control unit is configured to:
in response to the first voltage detection value corresponding to the low voltage level and the total power consumption value being greater than the first power threshold, generate a control signal to reduce the power consumption value of at least one of the power-consuming components so that the reduced total power consumption value is less than or equal to the first power threshold; and
in response to the first voltage detection value corresponding to the high voltage level and the total power consumption value being greater than the second power threshold, generate the control signal to reduce the power consumption value of at least one of the power-consuming components so that the reduced total power consumption value is less than or equal to the second power threshold.

11. A control method for a projection device, the projection device comprising a power conversion unit, a first detection unit, a second detection unit, a computation unit, and a control unit, the control method comprising the steps of:
detecting a voltage input to the power conversion unit by the first detection unit to generate a first voltage detection value;
detecting a current at one of an input end and an output end of the power conversion unit by the second detection unit to generate a current detection value;
calculating, by the computation unit, to obtain a total power consumption value corresponding to at least one power-consuming component according to the current detection value, and outputting the first voltage detection value and the total power consumption value; and
controlling, by the control unit, the power consumption of the at least one power-consuming component according to the first voltage detection value and the total power consumption value.

12. The control method of the projection device according to claim 11, wherein the step of calculating, by the computation unit, to obtain the total power consumption value corresponding to the at least one power-consuming component according to the current detection value further comprises the step of:
calculating, by the computation unit, to obtain the total power consumption value corresponding to the at least one power-consuming component according to the first voltage detection value and the current detection value.

13. The control method of the projection device according to claim 11, wherein, after the step of detecting a current at the input end or the output end of the power conversion unit by the second detection unit to generate a current detection value further comprises the step of:
detecting, by the computation unit, the voltage at the output end of the power conversion unit to generate a second voltage detection value.

14. The control method of the projection device according to claim 13, wherein the step of calculating, by the computation unit, to obtain a total power consumption value corresponding to at least one power-consuming component according to the current detection value further comprises the step of:
calculating, by the computation unit, to obtain the total power consumption value corresponding to the at least one energy-consuming component according to the second voltage detection value and the current detection value.

15. The control method of the projection device according to claim 11, wherein the step of controlling, by the control unit, the power consumption of the at least one power-consuming component according to the first voltage detection value and the total power consumption value comprises:
determining, by the control unit, whether the voltage input to the power conversion unit is at a low voltage level or a high voltage level according to the first voltage detection value;
in response to the first voltage detection value corresponding to the low voltage level, determining, by the control unit, whether the total power consumption value is greater than a first power threshold;
when the total power consumption value is greater than the first power threshold, generating, by the control unit, a control signal according to the total power consumption value and the first power threshold to reduce the power consumption of the at least one energy-consuming component; and
in response to the first voltage detection value corresponding to the high voltage level, determining, by the control unit, whether the total power consumption value is greater than a second power threshold;
when the total power consumption value is greater than the second power threshold, generating, by the control unit, the control signal according to the total power consumption value and the second power threshold to reduce the power consumption of the at least one energy-consuming component.

16. The control method of the projection device according to claim 11, wherein an number of the at least one power-consuming component is plural, each of the power-consuming components comprises a corresponding power consumption value, and the total of the corresponding power consumption values of each of the power-consuming components constitutes the total power consumption value, and the step of controlling, by the control unit, the power consumption of the at least one power-consuming component according to the first voltage detection value and the total power consumption value comprises:
determining, by the control unit, whether the voltage input to the power conversion unit is at a low voltage level or a high voltage level according to the first voltage detection value;
in response to the first voltage detection value corresponding to the low voltage level, determining, by the control unit, whether the total power consumption value is greater than a first power threshold;
when the total power consumption value is greater than the first power threshold, generating, by the control unit, a control signal according to the total power consumption value and the first power threshold to reduce the power consumption of the at least one energy-consuming component so that the reduced total power consumption value is less than or equal to the first power threshold; and
in response to the first voltage detection value corresponding to the high voltage level, determining, by the control unit, whether the total power consumption value is greater than a second power threshold;
when the total power consumption value is greater than the second power threshold, generating, by the control unit, the control signal according to the total power consumption value and the second power threshold to reduce the power consumption of the at least one energy-consuming component so that the reduced total power consumption value is less than or equal to the second power threshold.
